(19) United States
(12) Patent Application Publication
(10) Pub. No.: US 2019/0020811 A1
(43) Pub. Date: Jan. 17, 2019

(54) METHOD AND SYSTEM FOR ACQUIRING TERAHERTZ-GIGAHERTZ IMAGE

(71) Applicant: Archit System Inc., Hsinchu City (TW)

(72) Inventor: Lawrence Dah-Ching Tzuang, Hsinchu City (TW)

(21) Appl. No.: 15/649,697

(22) Filed: Jul. 14, 2017

(51) Int. Cl. H04N 5/232; H04N 5/33; H04N 5/225; H04N 5/235

(52) U.S. Cl. CPC H04N 5/23212; H04N 5/2354; H04N 5/2256; H04N 5/332

(57) ABSTRACT

Method and system that utilizes the information contained in a non-THz image to configure the THz image assembly for optimizing the acquired THz image of the objects of interest. By utilizing a non-THz image assembly operated in a frequency range outside the THz illumination range, a non-THz image of objects positioned in a region of interest is acquired. Then, by analyzing the non-THz image, the THz image assembly is configured to have THz image of the objects of interest with better THz image quality provided by correct focusing of the object of interest. Furthermore, the THz source providing the THz illumination also may also be adjusted so that the emitted THz illumination is concentrated on the objects of interest for efficient use of THz energy.

### FIELD OF THE INVENTION

The present invention relates to method and system for acquiring terahertz-gigahertz (THz) image, especially the method and the system that utilize the non-THz image to acquire information of objects of interest, and then configure the THz image assembly accordingly.

### BACKGROUND OF THE INVENTION

The interest in THz technology has significantly increased during the past decades, and the commercial applications utilizing THz systems have stably increased as well. For example, both the THz imaging system and the THz security system have valuable commercial values because of its unique THz illumination transmission properties. One classic example is the identification of concealed objects, such as a metal weapon hidden under a fiber cloth. Food inspection and biomedical detection are the two other emerging commercial applications.

The development of the lens-based THz technology has to confront some difficult challenges. For example, to compare with the conventional lens-based optical imaging, it is harder to identify the appropriate, even optimum, focusing condition with high fidelity. One reason is that the wavelength of the THz illumination within the frequency range from 0.01 THz to 10 THz is still much larger than optical wavelengths, which leads to low-resolution (blurry) THz images. Another reason is that the currently available THz image sensors usually have much fewer pixels than the optical sensors, which means that the THz image may not provide sufficient information to optimize the THz imaging system. Moreover, limited by the diffraction limit, the lenses are usually several times larger and heavier than lenses used in optical system. Therefore, it is harder and less efficient to hunt (move and/or tilt) the THz lens around to find the optimum focusing condition. Besides, the output power of the currently available commercial THz source is lower (to compare with the output power of the typical visible light or infrared ray source), such that the noise is more dominant, which makes image analysis more difficult. In addition, in a region where multiple objects are present, it is harder to simultaneously identify the appropriate, even optimized, focusing conduction for each object of interest.

Therefore, it is essential to provide new method and new system that acquire THz image complemented with appropriate focusing condition, especially new method and new system need not to further improve the THz image sensor and the THz lens themselves.

### SUMMARY OF THE INVENTION

The proposed invention utilizes a non-THz image assembly to find the information of the object(s) of interest. Hence, by analyzing the non-THz image, the appropriate focusing condition for acquiring THz image may be effectively performed, and the THz illumination emitted from the THz source may concentrate on, or close to, the object(s) of interest only.

In general, the non-THz image is a visible light image or an infrared image, because there are abundant commercial image sensors and sources. However, the invention does not limit what kind of image sensor is utilized to generate the non-THz image. Particularly, the non-THz image may have pixel values of distance and/or pixel values of EM illumination intensity. Hence, much information of the object(s) may be found, for example but not limited to size, shape, azimuth, direction, distance and color. Therefore, the object(s) of interest may be selected from all objects in the region of interest, and then the appropriate focusing condition for detecting it may be obtained accordingly.

As usual, the THz image assembly (at least includes the THz lens set and the THz image sensor) and the non-THz image assembly (at least includes the non-THz lens set and the non-THz image sensor) may be positioned close to each other or may be positioned away from each other. The only requirement is that both image assemblies may effectively detect the objects appeared in the area of interest. That is to say, the non-THz image assembly has to be able to detect all the objects that the THz image assembly detects. Of course, to avoid mutual interference, the non-THz image assembly should not obstruct or diffuse the propagation of the THz illumination, especially the direct path of the THz wave propagation from the objects of interest to the THz image sensor. For example, in a region that the non-THz image assembly is positioned close to the THz image assembly, the field-of-view of the non-THz image assembly is the same as or at least larger than the field-of-view of the THz image assembly, and the non-THz image assembly is placed near of the THz lens set but not obstructing the THz illumination from entering the THz lens set and the THz image sensor.

### BRIEF DESCRIPTION OF THE DRAWINGS

FIG. 1A and FIG. 1B briefly illustrates the basic configuration of two exemplary systems respectively.

FIG. 2A, FIG. 2B and FIG. 2C briefly illustrate the basic flowchart of three exemplary methods respectively.

### DETAILED DESCRIPTION OF THE INVENTION

Reference will now be made in details to specific embodiment of the present invention. Examples of these embodiments are illustrated in the accompanying drawings. While the invention will be described in conjunction with these specific embodiments, it will be understood that the intent is not to limit the invention to these embodiments. In fact, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without at least one of these specific details. In other instances, the well-known portions are less or not described in detail in order not to obscure the present invention.

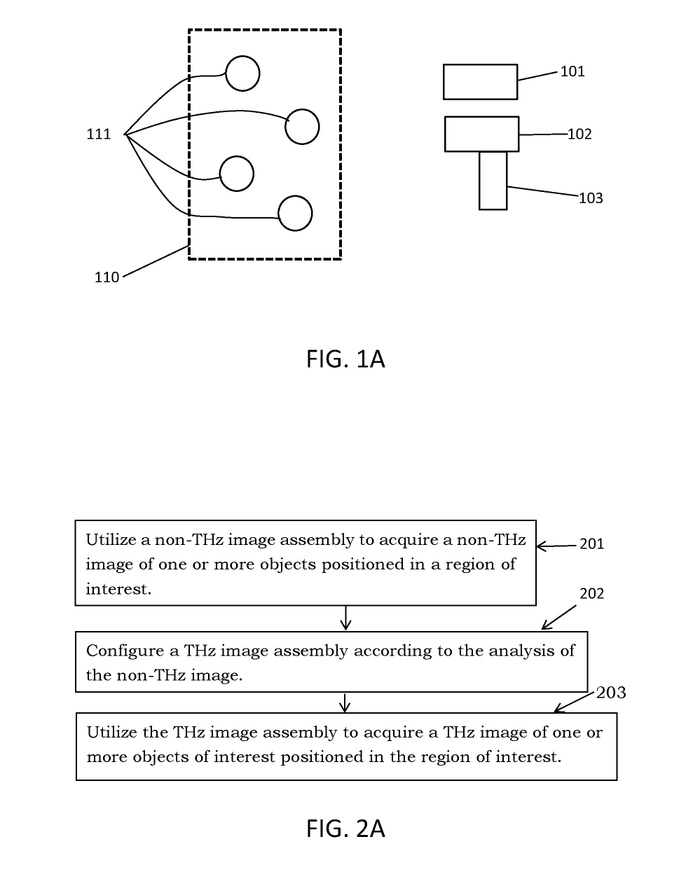

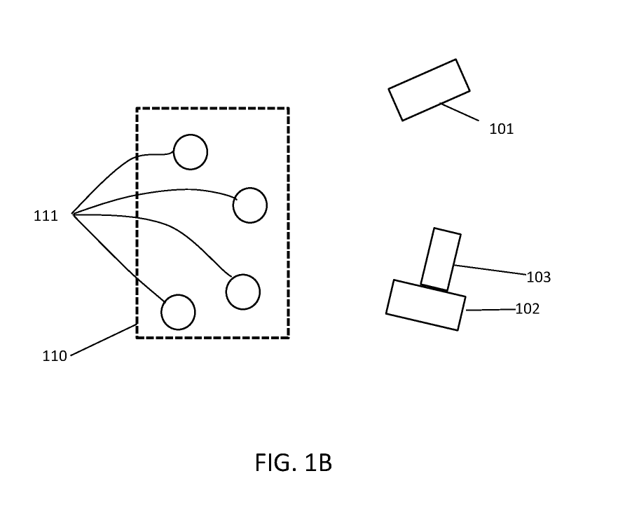

Two exemplary embodiments of this invention are related to the system for acquiring terahertz-gigahertz image. As shown in FIG. 1A and FIG. 1B, each of these exemplary embodiments has at least a non-THZ image assembly 101, a THZ image assembly 102 and a configuration assembly 103. The non-THz image assembly 101 is configured to acquire a non-THz image of one or more objects positioned in the region of interest 110, and the THz image assembly 102 is configured to acquire a THz image of one or more objects of interest 111 positioned in the region of interest 110, and the configuration assembly 103 is used to configure at least the THz image assembly 102 according to the analysis of the non-THz image. Furthermore, each object of interest 111 is selected from the objects in the region of interest 110 and the THz image assembly 102 is configured to detect all of the objects of interest 111. FIG. 1A briefly illustrates the situation that all objects in the region of interest 110 are the objects of interest 111, but the invention may be applied to other situations that only a portion of the objects in the region of interest 110 are selected and assigned as the objects of interest 111. For example, in the situation that the proposed system serves as a security tool to find concealed metal weapons, the non-THz image assembly 101 identifies all objects, such as the travelers and their hand-held luggage, and the THz image assembly 102 checks one or more of the travelers/luggage which are selected according to the analysis of the non-THz image of these travelers. Besides, the THz image assembly 102 has at least a lens set which has one or more lenses and a THz image sensor, and the configuration assembly 103 may be utilized to move and/or tilt at least one lens in the lens set and/or the THz image sensor. In this way, the THz image acquired by the THz image assembly 102 may be optimized with proper focusing. In addition, the details of the non-image assembly 101 are not limited, any well-known, on-developing and/or to-be-appeared assembly capable of acquiring non-THz image may be utilized. In general, the THz image assembly 102 captures THz illumination with frequencies from 0.01 THz to 10 THz, and the non-THz image assembly 101 captures EM illumination with frequencies outside of the range of 0.01 THz to 10 THz. For example, the non-THz image assembly 101 may be a visible light camera, an RGB camera, a black and white camera, a range camera, an infrared camera, a starlight night vision monitor, a time-of-flight camera, an ultrasonic distance measurement system or a laser radar.

As shown in FIG. 1A and FIG. 1B, one main feature of the invention is that both the THZ image assembly 102 and the non-THz image assembly 101 may detect the objects positioned in the same region of interest 110. In other words, the detectable region of the THz image assembly 102 is overlapped with at least a portion of the detectable region of the non-THz image assembly 101, wherein the overlapped portions is the region of interest 110 that the objects to be detected will appear. That is to say, they are configured so that the objects of interest 111 to be detected by the THz image assembly 102 also may be detected by non-THz image assembly 101. Of course, the configurations of both the non-THz image assembly 101 and the THz image assembly 102 should not interfere with each other. For example, the non-THz image assembly 101 should not obstruct or diffuse the propagation of THz illumination between the THz image assembly 102 and the objects of interest 111, even the propagation of the THz illumination between the objects of interest 111 and the THz source(s) emitting the THz illumination.

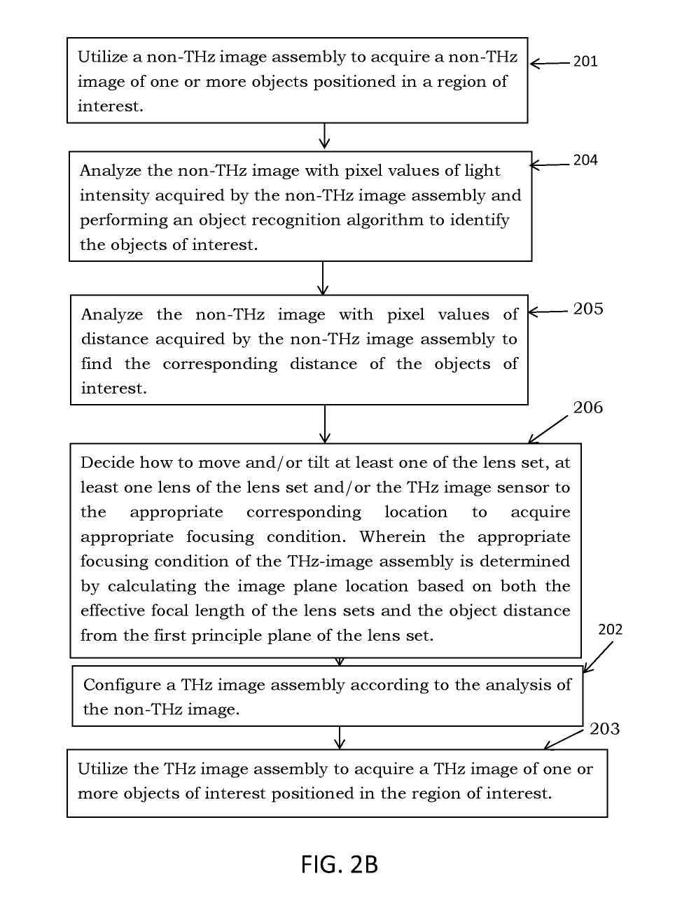

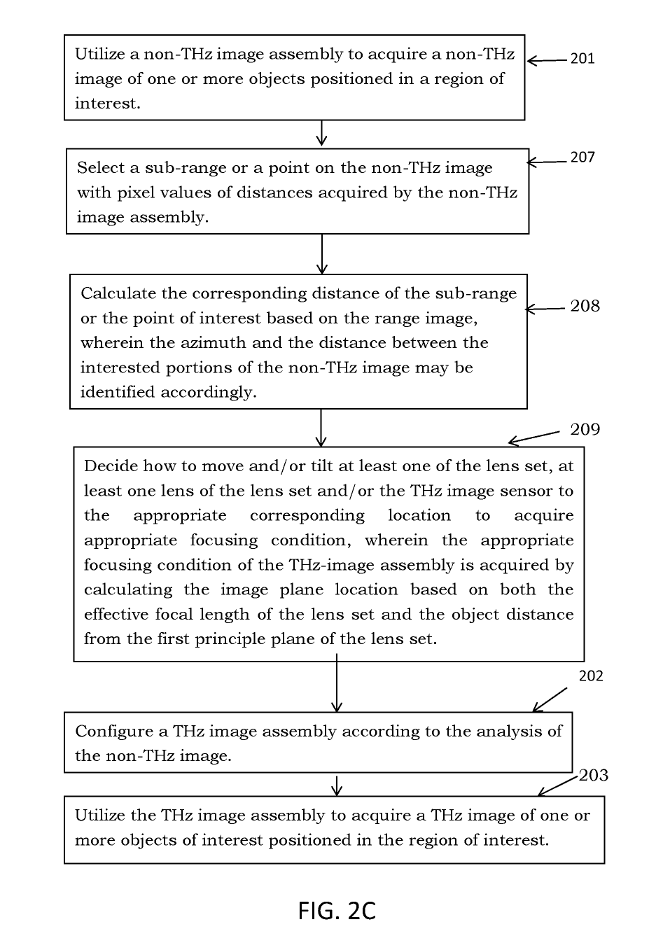

Significantly, by utilizing the proposed system as disclosed above, a method for acquiring terahertz-gigahertz image may be achieved. The essential flowchart of the method is shown in FIG. 2A. Initially, as shown in block 201, utilize a non-THz image assembly to acquire a non-THz image of one or more objects positioned in a region of interest. Next, as shown in block 202, configure the THz image assembly according to the analysis of the non-THz image. Then, as shown in block 203, utilize the THz image assembly to acquire a THz image of one or more objects of interest positioned in the region of interest.

Reasonably, because the geometrical relation between the non-THz image assembly 101 and the THz image assembly 102 is known (both assemblies are configured before the method being performed or before these objects being detected), the geometric relation between the objects of interest 111 and the THz image assembly 102 may be decided by analyzing the non-THz image acquired by the non-THz image assembly 101. That is to say, by analyzing the non-THz image, much information of all objects may be acquired simultaneously, such as the distance, the azimuth, the position, the size and the shape. According to the information of all objects, for each object of interest 111, the focal length or image plane of the THz image assembly 102 may be directly adjusted to an approximate focusing condition. In short, the THz image assembly 102 needs not to detect the whole region of interest 110 for finding all objects and may directly detect all objects of interest 111 with appropriate focusing conditions.

In contrast, in the situation that only the THz image assembly 102 is utilized, the THz image assembly 102 needs to detect the whole region of interest 110 for finding all objects. Reasonably, due to these difficult challenges discussed above, it is less effective and more difficult to detect the whole region of interest 110 to acquire information of all objects in the region of interest 110 by utilizing the THz image assembly 102 alone. Further, at least one of the lenses in the THz lens set and/or the THz image sensor has to be moved over a distance range during a period time to find the correct focusing conditions.

As a short summery, by utilizing the non-THz assembly 101, especially by utilizing the commercial non-THz assembly to acquire the non-THz image, it is more effective and simple to analyze the whole region of interest 110 to find all objects, to identify the objects of interest 111, and to have optimum THz image of the objects of interest 111 accordingly.

In addition, when the configuration assembly 103 is utilized to configure the THz image assembly 102, it is optional to maximize contrast of the produced THz image of at least one objects of interest 111. Further, it is optional to optimize the THz images of all objects of interest 111 with highest contrast sequentially (i.e., to acquire THz images of all objects of interest 111 respectively with highest contrast during a time period). The proposed invention does not limit the optimization function of the THz image assembly 102, which is dependent on what applications the proposed invention is applied.

Moreover, depending on the details of the non-THz assembly 101, the non-THz image may have pixel values of distance and/or pixel values of light intensity. Obviously, the image with pixel values of distance may indicate at least the azimuth and the distance of the objects between the non-THz assembly 101 and the objects, and the image with pixel values of light intensity may indicate at least the shape and size of the objects. Particularly, the invention may acquire detailed optical image of the objects because the commercial non-THz assembly 101 may have millions of pixels with good image quality. Therefore, depending on the details of the non-THz assembly 101, the essential flowchart shown in FIG. 2A may include several optional steps.

For example, as shown in FIG. 2B, between the steps present in block 201 and block 202, there are some optional steps as shown in block 204, 205 and 206 in the situation that the non-THz image assembly 201 may have non-THz images with pixel values of both light intensity and distance, respectively. Initially, as shown in block 204, analyze the non-THz image with pixel values of light intensity acquired by the non-THz image assembly and perform an object recognition algorithm to identify the objects of interest 111. In other words, potentially, one or more, even all, of the objects are identified as the objects of interest 111. Next, as shown in block 205, analyze the non-THz image with pixel values of distance acquired by the non-THz image assembly to find the distance of the corresponding objects of interest 111. In other words, the azimuth and the distance between the objects of interest 111 and the THz image assembly 102 may be identified accordingly. Then, as shown in block 206, decide how to move and/or tilt at least one of the lens set, at least one lens of the lens set and/or the THz image sensor to the appropriate corresponding location to achieve appropriate focusing condition. Wherein the appropriate focusing condition of the THz-image assembly is determined by calculating the image plane location based on both the effective focal length of the lens set and the object distance from the first principle plane of the lens set.

In another example, as shown in FIG. 2C, between the steps present in block 201 and block 202, there are some optional steps as shown in blocks 207, 208, and 209 in the situation that the non-THz image assembly 201 may produce a non-THz image with only pixel values of distance. Initially, as shown in block 207, select a sub-range or a point on the non-THz image with pixel values of distances acquired by the non-THz image assembly. In other words, identify which portions of the non-THz image should be further detected. Next, as shown in block 208, calculate the corresponding distance of the sub-range or the point of interest based on the range image, wherein the azimuth and the distance between the interested portions of the non-THz image may be identified accordingly. Then, as shown in block 209, decide how to move and/or tilt at least one of the lens set, the THz image sensor and/or at least one lens of the lens set to the appropriate corresponding location to achieve appropriate focusing condition, wherein the appropriate optimum focusing condition of the THz-image assembly is acquired by calculating the image plane location based on both the effective focal length of the lens set and the object distance from the first principle plane of the lens set.

One exemplary application of this invention is the remote sensing security gate. It is a big challenge to find the concealed metal weapon to avoid public danger, which is an increasingly important task especially after the incident of 911. Because the RGB camera and the range camera may target the travelers and their luggage through object identification, and also because the THz camera may find the metal weapon hidden under the fiber clothing or dielectric materials, the invention may be utilized to find the concealed metal weapon effectively. First, for all travelers and their luggage appeared on the monitored area, the RGB camera and the range camera are utilized to acquire pixel values of light intensity and pixel values of distance, respectively. Then, by analyzing the images acquired by both the RGB camera and the range camera, the appropriate focusing conditions of the THz camera for each traveler and each luggage are determined accordingly. Next, the THz image assembly is configured according to the appropriate focusing conditions accordingly to acquire the THz image. Of course, for each traveler and each luggage, because the concealed metal weapon cannot be detected by the RGB camera and the range camera, the focusing condition of the THz camera may be further slightly adjusted around the appropriate focusing condition so as to further optimize the THz image, i.e., to modify the appropriate focusing condition until the final focusing condition of the metal weapon is achieved.

One more advantage of the proposed invention is that the efficiency of the THz illumination emitted by the THz source may be further improved. When the objects in the region of interest are found by the non-THz image assembly, it is optional to let the THz source only illuminate the objects of interest, or only illuminate the objects of interest and their adjacent regions, like a focusing lamp. In other words, by analyzing the non-THz image acquired by the non-THz image assembly, not only the THz image assembly may be configured to have approximate focusing condition, but also the THz illumination pattern may be adjusted to fully utilize the capability of the THz source in use. This should prove to be very useful because the currently available THz source is both power limited and expensive. Therefore, by concentrating the THz illumination emitted by the THz source to illuminate on and/or around the objects of interest 111 but not over the entire region of interest, the power density of the THz illumination delivered to the objects of interest 111 may be greatly improved. In addition, depending on how the THZ image of the objects of interest 111 is acquired, the THz illumination may be concentrated to all objects of interest 111 simultaneously, to some objects of interest 111 simultaneously, or to different objects of interest 111 sequentially during a time period. Further, the configuration assembly 103 also may be utilized to move, tilt and/or adjust the THz source for adjusting how the THz illumination emitted by the THz source is concentrated on the objects of interest 111, or at least one of the objects of interest 111, sequentially during a time period.

Emphasize again that the geometrical relation between the non-THz image assembly 101 and the THz image assembly 102 is not limited whenever both the THz image assembly 102 and the non-THz image assembly 101 may acquire image of one or more objects positioned in the region of interest 110. For example, it is optional that the non-THz image assembly 101 does not affect the propagation of the THz illumination between the THz image assembly 102 and the objects positioned in the region of interest, and also is optional that the non-THz image assembly 101 does not affect the propagation of the THz illumination between the THz image assembly 102 and at least one object of interest 111 positioned in the region of interest. For another example, two optional and simple requirements in the situation that the non-THz image assembly 102 is positioned close to the THz image assembly 101 are listed as below: the field-of-view of the non-THz image assembly 101 is the same as or at least larger than the field-of-view of the THz image assembly 102.

Furthermore, the invention only requires that the configuration assembly 103 configures the THz image assembly 102 so as to optimize the THz image acquired by the THz image assembly 102, but does not limit the details of the THz image assembly 102 and the configuration assembly 103. Essentially, the configuration assembly 103 has at least a processing unit, such as an application-specific integrated circuit or a program set performed by a computer, and a driving unit, such as a combination of motors, sliders, and some mechanical fixtures. The driving unit is used to configure the THz image assembly 102 and the processing unit is used to decide how to configure the THz image assembly 102 according to the non-THz image. For example, the processing unit is configured to acquire the approximate focusing condition of the THz-image assembly by calculating the image plane location based on both the effective focal length of the set of the lens and the object distance acquired from a range camera. For example, the driving unit has an motor and several mechanical fixtures attached to different elements of the THz image assembly 102, wherein the motor is configured to move and/or tilt at least one of the mechanical fixture so as to move and/or tilt at least one of the THz image sensor and/or at least one lens of the lens set.

The presently disclosed embodiments should be considered in all respects to be illustrative and not restrictive. The scope of the invention is indicated by the appended claims rather than the foregoing description, and all variation which come within the meaning and range of equivalents thereof are intended to be embraced therein.

What is claimed is:

1. A method for acquiring terahertz-gigahertz image, comprising:
utilizing a non-THz image assembly to acquire a non-THz image of one or more objects positioned in a region of interest;
configuring a THz image assembly according to the non-THz image; and
utilizing the THz image assembly to acquire a THz image of one or more objects of interest positioned in the region of interest;
wherein the THz image assembly is operated with THz illumination with frequency from 0.01 THz to 10 THz;
wherein the non-THz image assembly is operated with EM illumination with frequency outside the range from 0.01 THz to 10 THz;
wherein the THz image assembly has at least a THz image sensor and a lens set with one or more lenses

2. The method as claimed in claim 1, further comprising:
analyzing the non-THz image with pixel values of light intensity acquired by the non-THz image assembly and performing an object recognition algorithm to identify the objects of interest;
analyzing the non-THz image with pixel values of distance acquired by the non-THz image assembly to find the corresponding distance of the object of interest; and
deciding how to move and/or tilt at least one of the lens set, at least one lens of the lens set and/or the THz image sensor to the appropriate corresponding location to acquire an appropriate focusing condition;
wherein the appropriate focusing condition of the THz-image assembly is acquired by calculating the image plane location based on both the effective focal length of the lens set and the object distance from the first principle plane of the lens set.

3. The method as claimed in claim 1, further comprising:
selecting a sub-range or a point on the non-THz image with pixel values of distances acquired by the non-THz image assembly;
calculating the corresponding distance of the sub-range or the point of interest based on the range image; and
deciding how to move and/or tilt at least one of the lens set, at least one lens of the lens set and/or the THz image sensor to the appropriate corresponding location to acquire an appropriate focusing condition;
wherein the appropriate focusing condition of the THz-image assembly is acquired by calculating the image plane location based on both the effective focal length of the lens set and the object distance from the first principle plane of the lens set.

4. The method as claimed in claim 1, further comprising at least one of the following:
configuring the THz image assembly such that the THz image of the objects of interest has highest contrast; and
configuring the THz image assembly such that the THz image of at least one objects of interest has highest contrast.

5. The method as claimed in claim 1, further comprising configuring the THz image assembly such that the THz image of each object of interest has maximum contrast in sequence.

6. The method as claimed in claim 1, further comprising at least one of the following steps for configuring the THz image assembly:
moving and/or tilting the lens set;
moving and/or tilting at least one lens of the lens set;
moving and/or tilting the image sensor; and
moving and/or tilting the THz source.

7. The method as claimed in claim 1, further comprising one of the following:
positioning the non-THz image assembly away from the THz image assembly, wherein both the THz image assembly and the non-THz image assembly may acquire image of one or more objects positioned in the region of interest;
positioning the non-THz image assembly close to the THz image assembly, wherein both the THz image assembly and the non-THz image assembly may acquire image of one or more objects positioned in the region of interest, wherein the non-THz image assembly does not affect the propagation of the THz illumination between the THz image assembly and the objects positioned in the region of interest; and
positioning the non-THz image assembly close to the THz image assembly, wherein both the THz image assembly and the non-THz image assembly may acquire image of one or more objects positioned in the region of interest, wherein the non-THz image assembly does not affect the propagation of the THz illumination between the THz image assembly and at least one objects of interest positioned in the region of interest.

8. The method as claimed in claim 1, further comprising at least one of the following:
positioning the non-THz image assembly close to the THz image assembly, wherein the field-of-view of the non-THz image assembly has the same field-of-view as of the THz image assembly; and
positioning the non-THz image assembly close to the THz image assembly, wherein the field-of-view of the non-THz image assembly is at least larger than the field-of-view of the THz image assembly.

9. The method as claimed in claim 1, further comprising one of the following:
adjusting a THz source so that the THz illumination emitted by the THz source is concentrated on the objects of interest simultaneously;
adjusting a THz source so that the THz illumination emitted by the THz source is concentrated on at least one of the objects of interest simultaneously;
adjusting a THz source so that the THz illumination emitted by the THz source is concentrated on the objects of interest sequentially during a time period; and
adjusting a THz source so that the THz illumination emitted by the THz source is concentrated on at least one of the objects of interest sequentially during a time period.

10. The method as claimed in claim 1, further comprising at least one of the following:
utilizing a range camera to form the non-THz image assembly;
utilizing a RGB camera to form the non-THz image assembly; and
utilizing a black and white camera to form the non-THz image assembly.

11. A system for acquiring terahertz-gigahertz image, comprising:
a non-THz image assembly configured to acquire a non-THz image of one or more objects positioned in a region of interest;
a THz image assembly configured to acquire a THz image of one or more objects of interest positioned in the region of interest; and
an configuration assembly configured to configure the THz image assembly according to the non-THz image;
wherein the THz image assembly is operated with THz illumination of frequencies ranging from 0.01 THz to 10 THz;
wherein the non-THz image assembly is operated with EM illumination of frequencies outside the range of 0.01 THz to 10 THz;
wherein the THz image assembly has at least a THz image sensor and a lens set with one or more lenses.

12. The system as claimed in claim 11, the configuration assembly being configured to perform at least one step of the following for configuring the THz image assembly:
moving and/or tilting the lens set;
moving and/or tilting at least one lens of the lens set; and
moving and/or tilting the image sensor.

13. The system as claimed in claim 11, the configuration assembly being configured to configure the THz image assembly for acquiring at least one of the following:
the THz image of the objects of interest with highest contrast;
the THz image of at least one objects of interest with highest contrast; and
the THz image of each object of interest with highest contrast in sequence.

14. The system as claimed in claim 11, the configuration assembly having at least a processing unit and a driving unit, wherein the driving unit is used to configure the THz image assembly and the processing unit is used to decide how to configure the THz image assembly according to the information provided by the non-THz image.

15. The system as claimed in claim 14, wherein the processing unit is configured to acquire an appropriate focusing condition of the THz-image assembly by calculating the image plane location based on both the effective focal length of the lens set and the object distance from the first principle plane of the lens set.

16. The system as claimed in claim 14, wherein the driving unit has a motor and several mechanical fixtures which attached to different elements of the THz image assembly respectively, wherein the motor is configured to move and/or tilt at least one of the mechanical fixture so as to move and/or tilt at least one of the lens of the lens set and/or the THz image sensor.

17. The system as claimed in claim 11, further comprising one of the following:
the non-THz image assembly is positioned away from the THz image assembly, wherein both the THz image assembly and the non-THz image assembly may acquire image of one or more objects positioned in the region of interest;
the non-THz image assembly is positioned close to the THz image assembly, wherein both the THz image assembly and the non-THz image assembly may acquire image of one or more objects positioned in the region of interest, wherein the non-THz image assembly does not affect the propagation of the THz illumination between the THz image assembly and the objects positioned in the region of interest; and
the non-THz image assembly is positioned close to the THz image assembly, wherein both the THz image assembly and the non-THz image assembly may acquire image of one or more objects positioned in the region of interest, wherein the non-THz image assembly does not affect the propagation of the THz illumination between the THz image assembly and at least one objects of interest positioned in the region of interest.

18. The system as claimed in claim 11, further comprising one of the following:
the non-THz image assembly is positioned close to the THz image assembly, wherein the field-of-view of the non-THz image assembly is the same as the field-of-view of the THz image assembly; and
the non-THz image assembly is positioned close to the THz image assembly, wherein the field-of-view of the non-THz image assembly is at least larger than the field-of-view of the THz image assembly;

19. The system as claimed in claim 11, further comprising at least one of the following:
the non-THz image assembly has a range camera configured to provide pixel values of distance;
the non-THz image assembly has a range camera being a time-of-flight camera;
the non-THz image assembly has a RGB camera configured to provide pixel values of light intensity in red-, blue-, and green-channels;
the non-THz image assembly has a color camera configured to provide colorful image of the objects positioned in the region of interest; and
the non-THz image assembly has a black and white camera configured to provide black and white image of the objects positioned in the region of interest.

20. The system as claimed in claim 11, further comprising a THz source configured to emit the THz illumination, wherein the configuration assembly is configured to perform at least one of the following:
adjusting the THz source so that the THz illumination emitted by the THz source is concentrated on the objects of interest simultaneously;
adjusting the THz source so that the THz illumination emitted by the THz source is concentrated on at least one of the objects of interest simultaneously;
adjusting the THz source so that the THz illumination emitted by the THz source is concentrated on the objects of interest sequentially during a time period; and
adjusting the THz source so that the THz illumination emitted by the THz source is concentrated on at least one of the objects of interest sequentially during a time period.
